(19) United States
(12) Patent Application Publication
(10) Pub. No.: US 2024/0120130 A1
(43) Pub. Date: Apr. 11, 2024

(54) WIRING MEMBER-EQUIPPED ADHEREND

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventor: Daichi FUKUSHIMA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/275,843

(22) PCT Filed: Feb. 4, 2022
(86) PCT No.: PCT/JP2022/004353

§ 371 Date: Aug. 4, 2023

(30) Foreign Application Priority Data
Feb. 24, 2021 (JP) 2021-027474

(51) Int. Cl. H01B 7/08; B60R 16/02; H01B 7/00

(52) U.S. Cl. CPC H01B 7/0846; B60R 16/0215; H01B 7/0045

(57) ABSTRACT

A wiring member-equipped adherend includes: a wiring member including a sheet and a wire-like transmission member bonded to the sheet; and an adherend provided in a position where the wiring member is disposed in a vehicle to be bonded to the sheet. A bonding part where the sheet and the adherend are bonded includes a lateral bonding part provided in a position deviated from the wire-like transmission member along a width direction of the sheet.

### TECHNICAL FIELD

The present disclosure relates to a wiring member-equipped adherend.

### BACKGROUND ART

Patent Document 1 discloses a wire harness in which an electrical wire is welded to a functional exterior member formed into a sheet-like shape.

### PRIOR ART DOCUMENTS

### Patent Document(s)

Patent Document 1: Japanese Patent Application Laid-Open No. 2018-137208

### SUMMARY

### Problem to be Solved by the Invention

A sheet in a wiring member such as a wire harness described in Patent Document 1 is bonded to an adherend with at least one of heating and pressurizing in some cases.

Accordingly, an object is to provide a technique of appropriately bonding a sheet in a wiring member and an adherend with at least one of heating and pressurizing.

### Means to Solve the Problem

A wiring member-equipped adherend according to the present disclosure includes: a wiring member including a sheet and a wire-like transmission member bonded to the sheet; and an adherend provided in a position where the wiring member is disposed in a vehicle to be bonded to the sheet, wherein a bonding part where the sheet and the adherend are bonded includes a lateral bonding part provided in a position deviated from the wire-like transmission member along a width direction of the sheet.

### Effects of the Invention

According to the present disclosure, the sheet in the wiring member and the adherend can be appropriately bonded with at least one of heating and pressurizing.

### BRIEF DESCRIPTION OF DRAWINGS

FIG. 1 is a plan view illustrating a wiring member-equipped adherend according to an embodiment 1.

FIG. 2 is a cross-sectional view along a II-II line in FIG. 1.

FIG. 3 is a drawing explaining a configuration of a second layer in a sheet.

FIG. 4 is a cross-sectional view illustrating a wiring member-equipped adherend according to an embodiment 2.

FIG. 5 is a plan view illustrating a wiring member-equipped adherend according to an embodiment 3.

FIG. 6 is a plan view illustrating a modification example of a sheet.

FIG. 7 is a plan view illustrating a wiring member-equipped adherend according to a first modification example.

FIG. 8 is a cross-sectional view along a XIII-XIII line in FIG. 7.

FIG. 9 is a plan view illustrating a wiring member-equipped adherend according to a second modification example.

### DESCRIPTION OF EMBODIMENT(S)

### Description of Embodiment of Present Disclosure

Embodiments of the present disclosure are listed and described firstly.

A wiring member-equipped adherend according to the present disclosure is as follows.
(1) A wiring member-equipped adherend includes: a wiring member including a sheet and a wire-like transmission member bonded to the sheet; and an adherend provided in a position where the wiring member is disposed in a vehicle to be bonded to the sheet, wherein a bonding part where the sheet and the adherend are bonded includes a lateral bonding part provided in a position deviated from the wire-like transmission member along a width direction of the sheet. The lateral bonding part is not overlapped with the wire-like transmission member, thus a heating amount and a pressurizing amount can be increased in forming the lateral bonding part. Accordingly, the sheet and the adherend can be firmly fixed to each other in the lateral bonding part, thus the sheet in the wiring member and the adherend are appropriately bonded with at least heating and pressurizing.
(2) In the wiring member-equipped adherend according to (1), a non-bonding part where the sheet and the adherend are not bonded may be provided in a portion overlapped with the wire-like transmission member adjacent to the bonding part along the width direction of the sheet. Accordingly, a whole portion along the width direction of the sheet is not bonded to the adherend.
(3) It is applicable that in the wiring member-equipped adherend according to (2), a press trace is formed in a surface of the sheet in the lateral bonding part, and a boundary between the bonding part and the non-bonding part is located closer to a side of the non-bonding part in relation to an edge of the press trace along the width direction of the sheet. It is confirmed that the boundary between the bonding part and the non-bonding part is located closer to the side of the non-bonding part in relation to the edge of the press trace, thus it is easily confirmed that the sheet and the adherend are firmly bonded in the lateral bonding part.
(4) In the wiring member-equipped adherend according to (2) or (3), the bonding part may include an overlapping bonding part provided adjacent to the lateral bonding part and partially overlapped with the wire-like transmission member. The overlapping bonding part is confirmed, thus it is easily confirmed that the sheet and the adherend are firmly bonded in the bonding part.
(5) It is applicable that in the wiring member-equipped adherend according to any one of (1) to (4), a plurality of spot bonding parts where the sheet and the wire-like transmission member are partially bonded along an extension direction of the wire-like transmission member are provided along the extension direction of the wire-like transmission member, and the bonding part is provided between the plurality of spot bonding parts along the extension direction of the wire-like transmission member. A distance from the bonding part to the spot bonding part is increased, thus heat and pressure in forming the bonding part are hardly transmitted to the spot bonding part.
(6) It is applicable that in the wiring member-equipped adherend according to any one of (1) to (5), the bonding part includes a hot-melt adhesive agent intervening between the sheet and the adherend, and a metal attached surface in the adherend has contact with the hot-melt adhesive agent. Accordingly, the metal attached surface is heated by induction heating, and the hot-melt adhesive agent can be heated by heat transmitted from the attached surface. Accordingly, heat in forming the bonding part is hardly transmitted to the wire-like transmission member.

### Detailed Description of Embodiment of Present Disclosure

Specific examples of a wiring member-equipped adherend according to the present disclosure are described hereinafter with reference to the drawings. The present disclosure is not limited to these examples, but is indicated by claims, and it is intended that meanings equivalent to claims and all modifications within a scope of claims are included.

### Embodiment 1

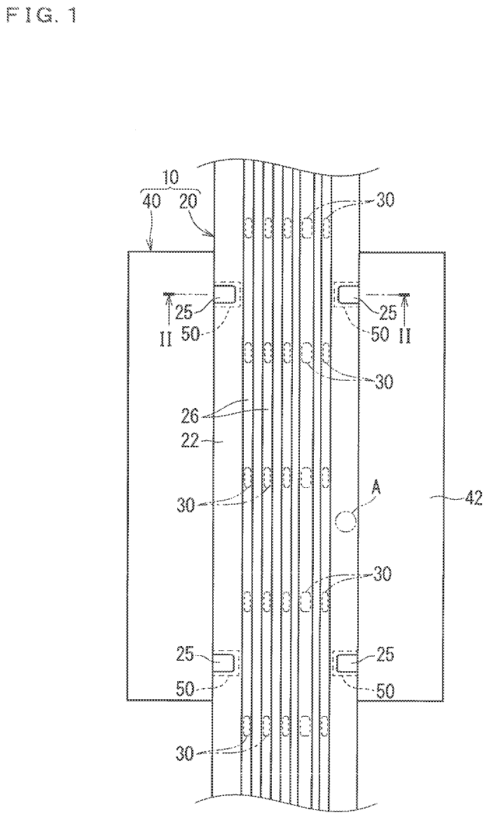

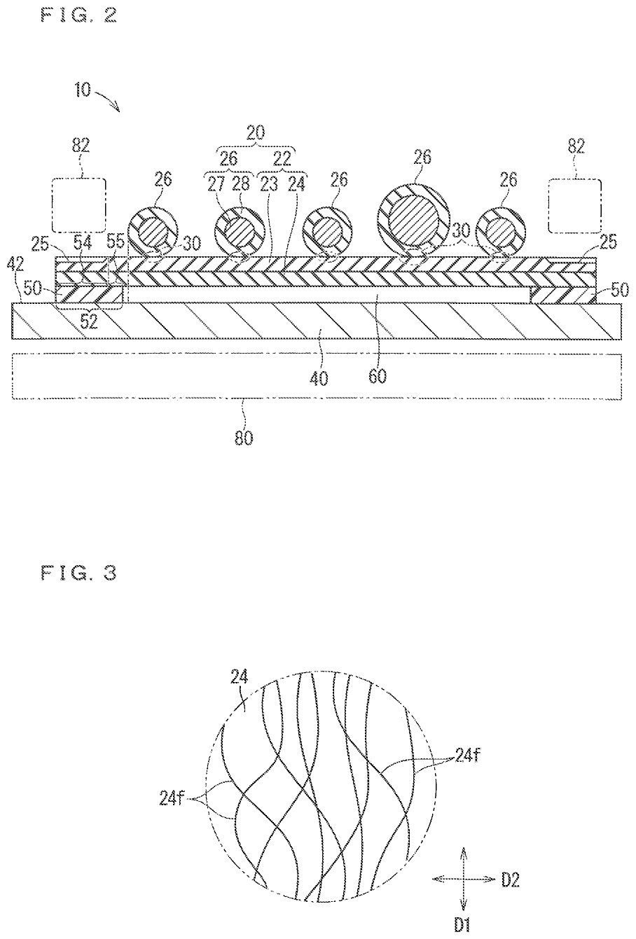

A wiring member-equipped adherend according to an embodiment 1 is described hereinafter. FIG. 1 is a plan view illustrating a wiring member-equipped adherend 10 according to the embodiment 1. FIG. 2 is a cross-sectional view along a II-II line in FIG. 1.

The wiring member-equipped adherend 10 includes a wiring member 20 and an adherend 40. The wiring member 20 is bonded to the adherend 40.

The wiring member 20 includes a sheet 22 and a wire-like transmission member 26. The wire-like transmission member 26 is bonded to the sheet 22. The plurality of wire-like transmission members 26 are arranged on a first surface of the sheet 22. Each of the plurality of wire-like transmission members 26 is bonded to the sheet 22. The plurality of wire-like transmission members 26 are arranged side by side on the first surface of the sheet 22. Accordingly, the wiring member 20 is flattened by reducing a dimension in a height direction in relation to dimensions in a width direction and a length direction.

It is sufficient that the sheet 22 can fix the wire-like transmission member 26, thus a material and a structure, for example, are not particularly limited. With regard to a material constituting the sheet 22, the sheet 22 is formed of a resin material herein. A material other than resin such as metal or an inorganic material, for example, may be used for the material constituting the sheet 22. With regard to the structure of the sheet 22, the sheet 22 has a double layer structure herein. The structure of the sheet 22 may be a single layer structure, or a multilayer structure of three or more layers is also applicable.

The sheet 22 includes a first layer 23 and a second layer 24. The first layer 23 is the fusion layer 23. The wire-like transmission member 26 is fused and fixed to the fusion layer 23. The fusion layer 23 includes a resin material, or preferably includes a thermoplastic resin material. The resin material of the fusion layer 23 is softened and fused to a fusion target. A type of the resin material is not particularly limited, but polyvinyl chloride (PVC), polyethylene (PE), polypropylene (PP), or polyethylene terephthalate (PET) can be adopted, for example.

A structure of the fusion layer 23 is not particularly limited. For example, the fusion layer 23 may be a sheet having an evenly filled cross-sectional surface (also referred to as a non-foam sheet or a solid sheet, for example). The fusion layer 23 is also considered a foam sheet, for example. The fusion layer 23 is also considered a fibrous material sheet such as a braided cloth, a woven cloth, or a non-woven cloth, for example. One surface of the first layer 23 is the first surface of the sheet 22.

The second layer 24 is formed of a material different from that of the fusion layer 23, or has a different structure. The second layer 24 increases a function of the fusion layer 23, or adds a function which the fusion layer 23 does not have to the sheet 22. A material constituting the second layer 24 is a material described for the fusion layer 23 described above, metal, or an inorganic material, for example. A structure of the second layer 24 may be any of the structure described for the fusion layer 23 described above. One surface of the second layer 24 is a second surface of the sheet 22.

The first layer 23 and the second layer 24 are fixed to each other while the other surface of the first layer 23 and the other surface of the second layer 24 have contact with each other. A fixing state of the first layer 23 and the second layer 24 is not particularly limited, however, fixing by fusion or adhesion is preferable. For example, when at least one of the first layer 23 and the second layer 24 is a sheet having voids in a surface such as a fibrous material sheet or a foam sheet, a resin material or an adhesive agent enters the voids and the layers can be fixed to each other. Such a configuration causes so-called anchor effect, thus the first layer 23 and the second layer 24 are rigidly fixed.

In the description herein, the first layer 23 is a solid sheet made of resin and the second layer 24 is a fibrous material sheet. In the description herein, the first layer 23 and the second layer 24 are fused to each other. That is to say, the resin of the first layer 23 enters between the fibers of the second layer 24 while having flowability, and is then hardened. Maintained accordingly is a state where the resin of the first layer 23 enters between the fibers of the second layer 24, and the first layer 23 and the second layer 24 are rigidly fixed to each other.

The first layer 23 and the second layer 24 are formed to have the same size (the same planar shape). One of the first layer 23 and the second layer 24 may also be formed to be larger than the other one thereof. The first layer 23 and the second layer 24 are wholly fixed at a region where they have contact with each other. The first layer 23 and the second layer 24 may also be fixed only at a part of a region where they have contact with each other.

The sheet 22 may be a flexible member. For example, the first layer 23 is a solid sheet made up of flexible resin such as flexible PVC as a material, the second layer 24 is a non-woven cloth made up of PET as a material, and the sheet 22 is a flexible member. For example, the sheet 22 may have a plastic property so as to be able to follow bending of the wire-like transmission member 26. It is also applicable that the wiring member 20 can be bended in a thickness direction (bending so that a fold line follows the main surface of the sheet 22).

The wire-like transmission member 26 is a wire-like member transmitting electrical power or light, for example. One or a plurality of wire-like transmission members 26 are provided. The wire-like transmission member 26 is assumed to be a member connecting components in a vehicle. A connector, for example, is provided on an end portion of the wire-like transmission member 26. This connector is connected to a connector provided in the other side component, thus the wire-like transmission member 26 is connected to the other side component. That is to say, the wiring member 20 is used as the wiring member 20 electrically connecting various types of component in a vehicle, for example (or connecting them so that they can perform optical communication). The connector may be fixed to the sheet 22.

A route of the wire-like transmission members 26 is set in accordance with a position of a component to which the wire-like transmission member 26 is connected, for example. The wire-like transmission members 26 are fixed to the sheet 22, thus the wire-like transmission members 26 are kept in a form following a wiring route corresponding to a position of a component as a connection destination of each wire-like transmission member 26. Herein, the wire-like transmission members 26 extend straight on the sheet 22. The sheet 22 is formed into a shape in accordance with a route of the wire-like transmission member 26 (straight shape, herein). However, the route of the wire-like transmission members 26 may be made up of a combination of a straight route and a bending route. The sheet 22 may also be made up of a combination of a straight route and a bending route. The plurality of wire-like transmission members 26 may be fixed to the sheet 22 in a state where a branch wire is branched from a main wire. The sheet 22 may also be formed into a shape in which a portion to which the branch wire is fixed is branched from a portion to which the main wire is fixed.

The wire-like transmission member 26 includes a transmission wire body 27 and a covering layer 28. The transmission wire body 27 is a transmission route transmitting electrical power or light. For example, when the wire-like transmission member 26 is an electrical wire, the transmission wire body 27 is a conductor core wire. The conductor core wire is made up of one or a plurality of strands. The strand is formed of copper, copper alloy, aluminum, or aluminum alloy as a material, for example. For example, when the wire-like transmission member 26 is an optical fiber, the transmission wire body 27 is a core and a clad. The covering layer 28 is a layer covering the transmission wire body 27. A resin material constituting the covering layer 28 is not particularly limited, but can be appropriately set. For example, the wire-like transmission member 26 may be a general wire having a core wire and a covering layer around the core wire, or may also be a shield wire, a twisted wire, an enamel wire, a nichrome wire, or an optical fiber.

The wire-like transmission member 26 transmitting the electrical power may be various kinds of signal lines or various kinds of power lines. Some of the wire-like transmission members 26 transmitting the electrical power may be used as an antenna or coil, for example, transmitting or receiving a signal or electrical power to or from a space.

The wire-like transmission member 26 may be a single core wire. The single core wire is a single wire-like object. The single core wire is the wire-like transmission member with one transmission route. The wire-like transmission member 26 may be a multicore wire. The multicore wire is a compound body of a plurality of wire-like objects. The multicore wire is the wire-like transmission member 26 with a plurality of transmission routes. The multicore wire may be a cable made up of collected twisted wires or a plurality of wire-like objects covered by a sheath, for example.

The sheet 22 and the wire-like transmission member 26 are fixed to each other via a spot bonding part 30 partially bonded along an extension direction of the wire-like transmission member 26. The plurality of spot bonding parts 30 are provided at intervals along the extension direction of the wire-like transmission member 26. The interval between the spot bonding parts 30 is not particularly limited, but can be appropriately set. However, the bonding part 30 between the sheet 22 and the wire-like transmission member 26 needs not be the spot bonding part 30. The bonding part 30 between the sheet 22 and the wire-like transmission member 26 may be continuously provided to have a large length along the extension direction of the wire-like transmission member 26.

Any fixing state may be applied as a fixing state in the bonding part 30 between the sheet 22 and the wire-like transmission member 26. Applicable as the fixing state are a contact area fixation and a non-contact area fixation, or both fixations may be used together. Herein, the contact area fixation indicates that a portion where the sheet 22 and the wire-like transmission member 26 have contact with each other is stuck and fixed. The non-contact area fixation is a fixing state which is not the contact area fixation, and indicates that a sewing thread, a cover, or an adhesive tape presses the wire-like transmission member 26 toward the sheet 22 or sandwiches the sheet 22 and the wire-like transmission member 26 to keep them in a fixing state. Tn the description hereinafter, the sheet 22 and the wire-like transmission member 26 are in the state of the contact area fixation.

Applicable as the configuration of the contact area fixation are a contact area indirect fixation and a contact area direct fixation, or both fixations may also be used together in different regions. Herein, the contact area indirect fixation indicates that the sheet 22 and the wire-like transmission member 26 are indirectly stuck and fixed via an adhesive member such as an adhesive agent, a gluing agent, and a double-sided adhesive tape provided therebetween. The contact area direct fixation indicates that the sheet 22 and the wire-like transmission member 26 are directly stuck and fixed without an intervention of the adhesive agent, for example, which is separately provided. Considered in the contact area direct fixation is that resin included in at least one of the sheet 22 and the wire-like transmission member 26 is melted, thus the sheet 22 and the wire-like transmission member 26 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as welding, fusion, and melting joint can be used. Herein, in the bonding part 30 between the sheet 22 and the wire-like transmission member 26, the sheet 22 and the wire-like transmission member 26 are fused to each other. In this case, the fusion layer 23 of the sheet 22 and an outermost layer of the wire-like transmission member 26 are fused to each other. The outermost layer of the wire-like transmission member 26 is the covering layer 28. It is sufficient that a material of the covering layer 28 and a material of the fusion layer 23 have compatibility. Herein, a resin material constituting the covering layer 28 and a resin material constituting the fusion layer 23 are the same type of material. A resin material constituting the fusion layer 23 and a resin material constituting the covering layer 28 are PVC or polyolefin, for example.

The adherend 40 is provided in a position where the wiring member 20 is disposed in a vehicle. A first end portion of the wiring member 20 extends to an outer side from a first end portion of the adherend 40. A second end portion of the wiring member 20 extends to an outer side from a second end portion of the adherend 40. One of or both the first end portion and the second portion of the wiring member 20 may be disposed on the adherend 40. The adherend 40 is bonded to the sheet 22. The second surface of the sheet 22 is bonded to an attached surface 42 of the adherend 40. Herein, the attached surface 42 is made of metal. The adherend 40 is a member including a metal member such as a single body of a metal member or a composite member of a metal member and a resin member, for example. A surface of this metal member serves as the attached surface 42. However, the attached surface 42 may be made of resin. In this case, the adherend 40 is a member including a resin member such as a single body of a resin member or a composite member of a metal member and a resin member, for example.

The adherend 40 may be a member previously assembled to a vehicle before the wiring member 20 is assembled to the vehicle. The adherend 40 and the wiring member 20 may be transported to a vehicle assembly plant separately from each other. For example, the adherend 40 may be a body panel or a body frame.

The adherend 40 may be a vehicle-mounted component and a member assembled to a vehicle together with the wiring member 20. The adherend 40 and the wiring member 20 may be transported to a vehicle assembly plant in a state of the wiring member-equipped adherend 10. The adherend 40 may be a bracket, for example.

It is sufficient that a fixing state of a bonding part 50 between the sheet 22 and the adherend 40 is accompanied with at least one of heating and pressurizing, and applicable are various types of fixing state described in the fixing state of the bonding part 30 between the sheet 22 and the wire-like transmission member 26. In the description of the present example, the fixing state of the bonding part 50 is the contact area indirect fixation. In the description, an adhesive member at this time is a hot-melt adhesive agent. In the description, the fixing state of the bonding part 50 is accompanied with both heating and pressurizing. Accordingly, the bonding part 50 between the sheet 22 and the adherend 40 herein includes a hot-melt adhesive agent intervening between the sheet 22 and the adherend 40. The metal attached surface 42 of the adherend 40 has contact with the hot-melt adhesive agent. The second surface of the sheet 22 has contact with the hot-melt adhesive agent. Herein, the second surface of the sheet 22 is a surface of a non-woven cloth layer. Thus, there may also be a case where a part of the hot-melt adhesive agent seeps into the non-woven cloth layer. In this case, bonding strength between the hot-melt adhesive agent and the sheet 22 is increased.

The bonding part 50 can be formed using an induction heating apparatus 80 and a press member 82 as illustrated in FIG. 2, for example. When high-frequency waves flow in a coil provided to the induction heating apparatus 80, current (eddy current) occurs in a metal member having the attached surface 42 due to change of magnetic force. The metal member having the attached surface 42 is heated by Joule heat due to the eddy current. The hot-melt adhesive agent having contact with the attached surface 42 is heated by thermal transmission from the attached surface 42 and softened, and is then bonded to the attached surface 42 of the adherend 40 and the second surface of the sheet 22. At this time, the first surface of the sheet 22 is pressed by the press member 82, thus bonding strength of the bonding part 50 is increased. Accordingly, the bonding part 50 is formed. The hot-melt adhesive agent may be previously bonded to one of the attached surface 42 of the adherend 40 and the second surface of the sheet 22 before forming the bonding part 50.

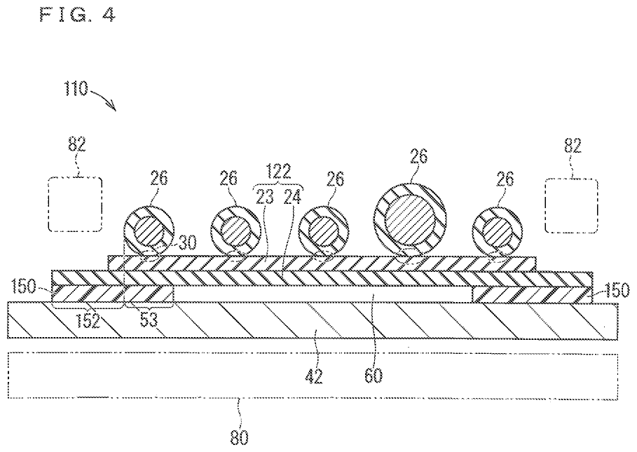

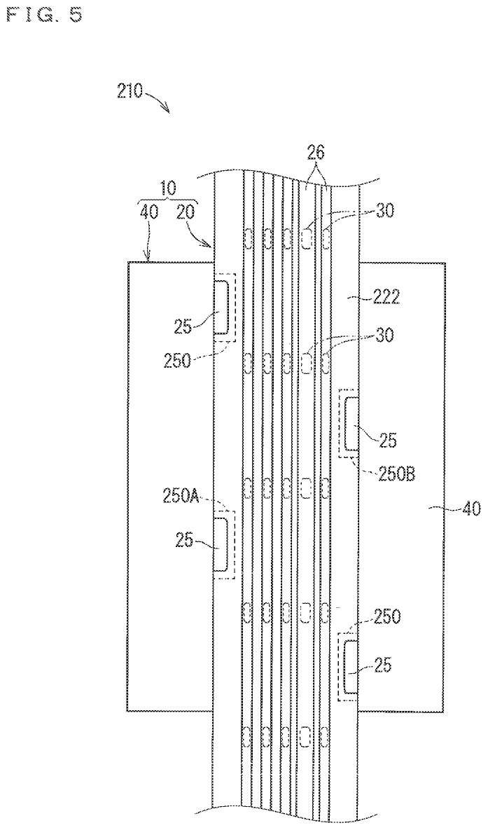

When the bonding part 50 is observed along the width direction of the sheet 22, the bonding part 50 includes a lateral bonding part 52. The lateral bonding part 52 is a part of the bonding part 50 provided in a position deviating from the wire-like transmission member 26 along the width direction of the sheet 22. Furthermore, the bonding part may include an overlapping bonding part 53 (refer to FIG. 4). The overlapping bonding part 53 is a part of the bonding part provided in a position overlapping with the wire-like transmission member 26 along the width direction of the sheet 22. When the wire-like transmission members 26 are disposed to be slightly separated from each other as illustrated in FIG. 2, a part provided in a position overlapped with a part between the wire-like transmission members 26 may also be deemed to be the overlapping bonding part.

In the present example, the bonding part 50 includes only the lateral bonding part 52 in the lateral bonding part 52 and the overlapping bonding part 53, and does not include the overlapping bonding part 53. An example that the bonding part includes the overlapping bonding part 53 is described in an example in an embodiment 2 described hereinafter.

Herein, the wire-like transmission member 26 is disposed in an intermediate portion of the sheet 22 along the width direction. The lateral bonding part 52 is provided in both end portions of the sheet 22 along the width direction. However, it is also applicable that the wire-like transmission member 26 is disposed in both end portion of the sheet 22 along the width direction, and the lateral bonding part 52 is provided in the intermediate portion of the sheet 22 along the width direction. It is also applicable that the wire-like transmission member 26 is disposed in one end portion of the sheet 22 along the width direction, and the lateral bonding part 52 is provided in the other end portion of the sheet 22 along the width direction.

A non-bonding part 60 is provided to the wiring member-equipped adherend 10. The non-bonding part 60 is a part where the sheet 22 and the adherend 40 are not bonded to each other. The non-bonding part 60 is provided in a portion overlapped with the wire-like transmission member 26 adjacent to the bonding part 50 along the width direction of the sheet 22. Herein, the bonding part 50 has a thickness of the hot-melt adhesive agent, thus the sheet 22 and the wire-like transmission member 26 are separated from each other in the non-bonding part 60. A member other than the wiring member 20 and the adherend 40 is not disposed to the non-bonding part 60. Accordingly, an air layer can be deemed to be disposed in the non-bonding part 60.

In the non-bonding part 60, the sheet 22 may be warped toward the adherend 40 by a weight of the sheet 22 itself and a weight of the wire-like transmission member 26, thereby reducing the air layer. As a dimension of the non-bonding part 60 along the width direction of the sheet increases, the sheet 22 is warped more easily. In the similar manner, as rigidity of the sheet 22 decreases, the sheet 22 is warped more easily. The non-bonding part 60 may include a part where the warped sheet 22 has contact with the adherend 40. The warped sheet 22 may not have contact with the adherend 40 in the non-bonding part 60.

A press trace 25 is formed in the surface of the sheet 22 in the lateral bonding part 52. The press trace 25 has a concaved shape in which the surface of the sheet 22 is partially concaved. The press trace 25 is a trace formed by pressing the surface of the sheet 22 with the press member 82 when the wiring member 20 and the adherend 40 are bonded to each other. The thickness of the sheet 22 in a part where the press trace 25 is formed may be smaller than that of the sheet 22 in a part around the part of the press trace 25. The thickness of the bonding part 50 in a part where the press trace 25 is formed may be smaller than that of the bonding part 50 in a part around the part of the press trace 25. A boundary between the bonding part 50 and the non-bonding part 60 is located closer to a side of the non-bonding part 60 in relation to an edge of the press trace 25 along the width direction of the sheet 22.

The bonding part 50 includes a pressurized part 54 and a protrusion part 55. The pressurized part 54 is a part pressed by the press member 82. In the present disclosure, a part of the bonding part 50 overlapped with the press trace 25 is the pressurized part 54. Herein, the press trace 25 is provided to the surface of the sheet 22 in the lateral bonding part 52, thus the lateral bonding part 52 includes the pressurized part 54.

The protrusion part 55 is a part protruding to the side of the non-bonding part 60 along the width direction of the sheet 22 more than the press trace 25 in the bonding part 50. Herein, the press trace 25 is formed in a region smaller than the lateral bonding part 52, thus the lateral bonding part 52 includes at least a part of the protrusion part 55. Herein, the protrusion part 55 does not protrude to a region overlapped with the wire-like transmission member 26. Thus, herein, the lateral bonding part 52 includes the whole protrusion part 55.

The protrusion part 55 may include a region overlapped with the wire-like transmission member 26. The overlapping bonding part 53 includes a region in the protrusion part 55 overlapped with the wire-like transmission member 26. When the press trace 25 is formed to have the same size as the lateral bonding part 52 along the width direction of the sheet 22, the protrusion part 55 is not included in the lateral bonding part 52 but is included in the overlapping bonding part 53.

The bonding part 50 is provided between the plurality of spot bonding parts 30 along the extension direction of the wire-like transmission member 26.

FIG. 3 is a drawing explaining a configuration of the second layer 24 in the sheet 22. FIG. 3 is a schematic view enlarging the second layer 24 of the sheet 22 in a region A in FIG. 1.

Herein, the second layer 24 is a long-fibered non-woven cloth layer 24. The non-woven cloth is broadly divided into a short-fibered non-woven cloth and a long-fibered non-woven cloth in accordance with a length of a fiber 24f constituting the non-woven cloth. Examples of the long-fibered non-woven cloth include a spunbond non-woven cloth and a melt-blow non-woven cloth. In the long-fibered non-woven cloth, each fiber 24f constituting the non-woven cloth is long, and the fibers 24f are twisted together and extend in a predetermined direction. Accordingly, the long-fibered non-woven cloth layer has a feature that tensile strength along an extension direction D1 (an up-down direction in the example in FIG. 3) of the fiber 24f is higher than that along a direction D2 (a right-left direction in FIG. 3) perpendicular to the extension direction D1.

At this time, it is sufficient that a dimension of the bonding part 50 along the direction D2 perpendicular to the extension direction D1 of the fiber 24f is larger than that along the extension direction D1 of the fiber 24f. When peel force is applied to the bonding part 50 along the extension direction D1 of the fiber 24f, the bonding part 50 withstands the peel force easily by the long-fibered non-woven cloth layer 24. When peel force is applied to the bonding part 50 along the direction D2 perpendicular to the extension direction D1 of the fiber 24f, the bonding part 50 withstands the peel force easily by the bonding part 50 itself. In the present example, the sheet 22 is formed so that the extension direction D1 of the fiber 24f is the extension direction of the sheet 22 (the extension direction of the wire-like transmission member 26). Thus, the dimension along the width direction of the sheet 22 is longer than that along the extension direction of the sheet 22 in the bonding part 50.

According to the wiring member-equipped adherend 10 having the above configuration, the lateral bonding part 52 is not overlapped with the wire-like transmission member 26, thus a heating amount and a pressurizing amount can be increased in forming the lateral bonding part 52. Accordingly, the sheet 22 and the adherend 40 can be firmly fixed in the lateral bonding part 52.

The non-bonding part 60 where the sheet 22 and the adherend 40 are not bonded is provided in the portion overlapped with the wire-like transmission member 26 adjacent to the bonding part 50 along the width direction of the sheet 22. Accordingly, the whole portion along the width direction of the sheet 22 is not bonded to the adherend 40.

The boundary between the bonding part 50 and the non-bonding part 60 is located closer to the side of the non-bonding part 60 in relation to the edge of the press trace 25 along the width direction of the sheet 22. It is confirmed that the boundary between the bonding part 50 and the non-bonding part 60 is located closer to the side of the non-bonding part 60 in relation to the edge of the press trace 25, thus it is easily confirmed that the sheet 22 and the adherend 40 are firmly bonded in the lateral bonding part 52.

The bonding part 50 is provided between the plurality of spot bonding parts 30 along the extension direction of the wire-like transmission member 26. Accordingly, a distance from the bonding part 50 to the spot bonding part 30 gets larger than a case where the bonding part 50 is provided in the same region as the spot bonding part 30 along the extension direction of the wire-like transmission member 26. Accordingly, heat and pressure in forming the bonding part 50 is hardly transmitted to the spot bonding part 30.

The metal attached surface 42 of the adherend 40 has contact with the hot-melt adhesive agent. Accordingly, the metal attached surface 42 is heated by induction heating, and the hot melt adhesive agent can be heated by heat transmitted from the attached surface 42. Accordingly, heat in forming the bonding part 50 is hardly transmitted to the wire-like transmission member 26. The air layer is provided between the sheet 22 and the adherend 40, thus the heat from the attached surface 42 is hardly transmitted to the wire-like transmission member 26 when the attached surface 42 is induction-heated.

### Embodiment 2

A wiring member-equipped adherend according to an embodiment 2 is described. FIG. 4 is a cross-sectional view illustrating a wiring member-equipped adherend 110 according to the embodiment 2. In the following description of the present embodiment, the same reference numerals are assigned to the similar constituent elements described above, and the description thereof will be omitted. The same applies to the description of each embodiment and modification example hereinafter.

The wiring member-equipped adherend 110 of the present example is different from the wiring member-equipped adherend 10 described above in that a bonding part 150 is overlapped with a lateral bonding part 152 and an overlapping bonding part 53 is included. As described above, the overlapping bonding part 53 is provided in a portion overlapped with the wire-like transmission member 26. In addition to the overlapping bonding part 53, the non-bonding part 60 is also provided in the portion overlapped with the wire-like transmission member 26. The non-bonding part 60 and the overlapping bonding part 53 are partially overlapped with the wire-like transmission member 26 in regions different from each other along the width direction of the sheet 122. The overlapping bonding part 53 is provided adjacent to the lateral bonding part 152 along the width direction of the sheet 122. The overlapping bonding part 53 is provided between the lateral bonding part 152 and the non-bonding part 60 along the width direction of the sheet 122.

The overlapping bonding part 53 is provided in the wiring member-equipped adherend 110, thus it is easily confirmed that the sheet 122 and the adherend 40 are firmly bonded in the bonding part 150 by confirming the overlapping bonding part 53.

A shape of the sheet 122 in the present example is different from that of the sheet 22 described above in that the first layer 123 is formed to have a smaller length in the width direction than the second layer 24. Accordingly, a part of the second layer 24 is exposed to a first surface of the sheet 122 in addition to the first layer 123. The first layer 123 is partially provided on the second layer 24 along the width direction, thus a weight and cost of the sheet 122 can be reduced compared with a case where the first layer 123 is provided on the whole second layer 24.

In the sheet 122, the wire-like transmission member 26 is disposed on the surface of the first layer 123. In the sheet 122, the wire-like transmission member 26 is not disposed in a portion where the first layer 123 is not located (the surface of the second layer 24). In the sheet 122, the bonding part 150 is provided to a portion where the first layer 123 is not located. A part of the bonding part 150 protrudes to the portion where the first layer 123 is located. As illustrated in FIG. 4, the lateral bonding part 152 includes a portion of the bonding part 150 provided to the portion where the first layer 123 is not located in the sheet 122. The lateral bonding part 152 includes a part of the bonding part 150 provided to the portion where the first layer 123 is located in the sheet 22, and the overlapping bonding part 53 includes the other part thereof.

In the present example, the press trace 25 is not formed in the surface of the sheet 122. The press trace 25 is hardly marked on the sheet 122. A part of the second layer 24 exposed to the first surface is pressed. At this time, the second layer 24 is the non-woven cloth layer, thus the press trace 25 is hardly marked when the second layer 24 pressed compared with the first layer 23 as a solid sheet.

The press trace 25 is hardly marked on the sheet even when force for pressing is weakened. Thus, there may also be a case where the second layer is not exposed to the first surface of the sheet 22 and the press trace 25 is not marked on the sheet 22 also in the wiring member in which the first layer 23 is pressed as with the wiring member 20 according to the embodiment 1.

### Embodiment 3

A wiring member-equipped adherend according to an embodiment 3 is described. FIG. 5 is a plan view illustrating a wiring member-equipped adherend 210 according to the embodiment 3.

In the present example, a sheet 222 is formed so that the extension direction D1 of the fiber 24f follows a width direction of the sheet 222. In this case, it is sufficient that the dimension along an extension direction of the sheet 222 is longer than that along the width direction of the sheet 222 in a bonding part 250. When peel force is applied to the bonding part 250 along the extension direction of the sheet 222, the bonding part 250 withstands the peel force easily by the bonding part 250 itself. When peel force is applied to the bonding part 250 along the width direction of the sheet 222, the bonding part 250 withstands the peel force easily by the long-fibered non-woven cloth layer 24.

In the present example, a bonding part 250A provided in one end portion of the sheet 222 along the width direction and a bonding part 250B provided in the other end portion thereof are disposed in positions deviating from each other along the extension direction of the sheet 22. An arrangement of the bonding parts 250A and 250B are a zig-zag arrangement. An arrangement of the bonding part may be a zigzag arrangement in each wiring member-equipped adherend.

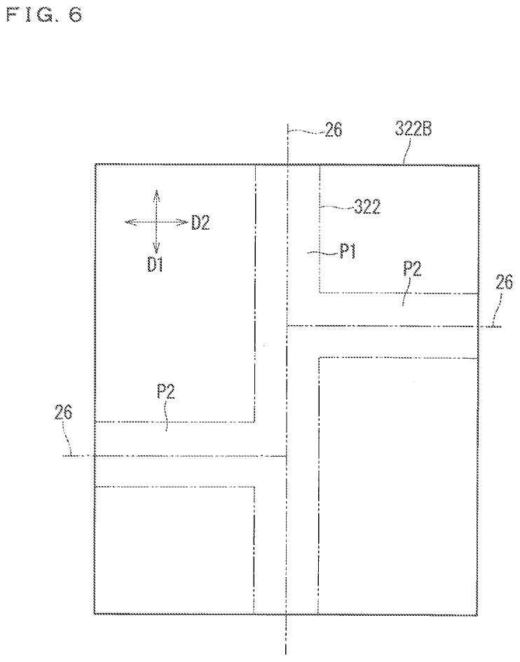

FIG. 6 is a plan view illustrating a modification example of the sheet 22. A sheet 322 according to the modification example is cut out from a raw sheet 322B larger than the sheet 322. The sheet 322 is cut out into a shape having a route bending part or a branch part. The wire-like transmission member 26 is disposed on the sheet 322 while its route being bended or branched in accordance with the shape of the sheet 322.

In this case, an extension part P1 along an extension direction of the sheet 322 and an extension part P2 along a width direction thereof may occur in the sheet 322. When the extension part P1 is fixed to the adherend 40, it is sufficient that the extension part P1 is fixed by the bonding part 50 in which a dimension of the sheet 322 along the width direction is larger than that along the extension direction as with the bonding part 50 according to the embodiment 1. When the extension part P2 is fixed to the adherend 40, it is sufficient that the extension part P2 is fixed by the bonding part 250 in which a dimension of the sheet 322 along the extension direction is larger than that along the width direction as with the bonding part 250 according to the embodiment 3.

### Modification Example

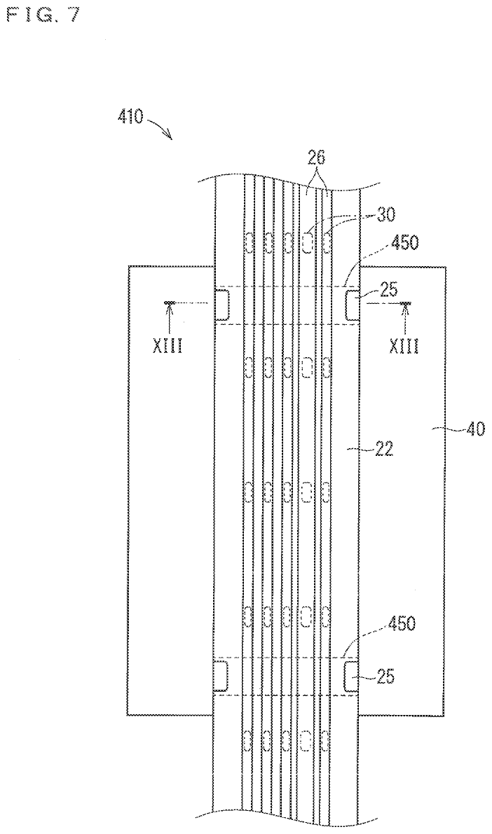

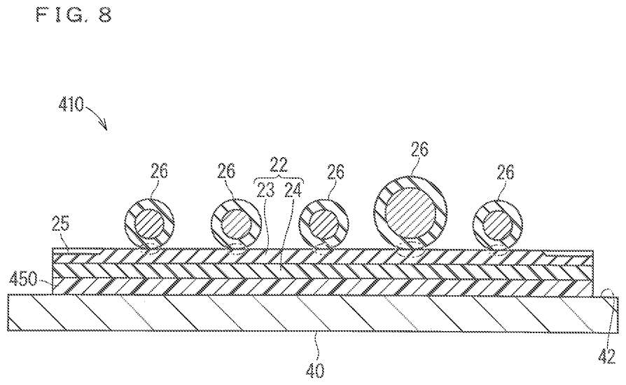

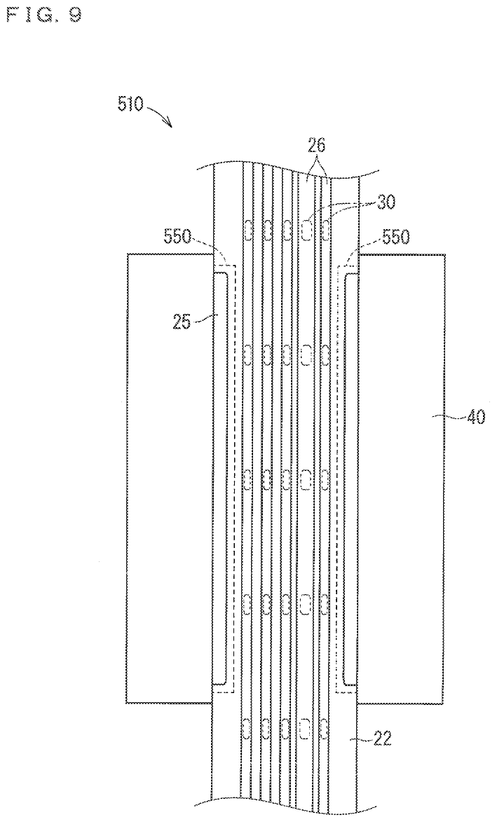

FIG. 7 is a plan view illustrating a wiring member-equipped adherend 410 according to a first modification example. FIG. 8 is a cross-sectional view along a XIII-XIII line in FIG. 7.

In the above description, the non-bonding part 60 is provided adjacent to the bonding part 50 along the width direction of the sheet 22, however, this configuration is not necessary. The non-bonding part 60 may not be provided adjacent to the bonding part 50 along the width direction of the sheet 22. For example, a bonding part 450 may be continuously provided over a whole region in a width direction as with a wiring member-equipped adherend 410 in the present example. In this case, the bonding part 450 may be provided at intervals along the extension direction of the sheet 22. Accordingly, the non-bonding part 60 is provided adjacent to the bonding part 450 along the extension direction of the sheet 22.

FIG. 9 is a plan view illustrating a wiring member-equipped adherend 510 according to a second modification example.

In the above description, the bonding part 50 is provided between the spot bonding parts 30, however, this configuration is not necessary. The bonding part 50 may be provided in a position of the spot bonding part. For example, as with the wiring member-equipped adherend 510 in the present example, a bonding part 550 may be provided to have a length equal to or larger than the interval between the spot bonding parts 30 along the extension direction of the sheet 22, or may also be continuously provided over a whole region in the extension direction of the sheet 22. For example, the bonding part 50 having shorter length than the sheet 22 along the extension direction of the sheet 22 may be provided in the same position as the spot bonding part 30 along the extension direction of the sheet 22 as with the bonding part 50 in FIG. 1.

A melting point of the sheet 22 in the lateral bonding part 52 may be lower than that of the sheet 22 in the non-bonding part 60. Accordingly, a fusion state of the bonding part is hardly resolved even when the lateral bonding part 52 is formed after the sheet 22 and the wire-like transmission member 26 are fused to form the bonding part 30.

A heat insulating material may be provided between the sheet 22 and the adherend 40 in the non-bonding part 60. The heat insulating material may be fixed to both the sheet 22 and the adherend 40, or may also be fixed to only one of the sheet 22 and the adherend 40. The heat insulating material is provided between the sheet 22 and the adherend 40, thus the heat from the attached surface 42 is hardly transmitted to the wire-like transmission member 26 when the attached surface 42 is induction-heated.

The configurations described in the embodiments and modification examples thereof can be appropriately combined as long as they are not contradictory.

### EXPLANATION OF REFERENCE SIGNS

10, 110, 210, 410, 510 wiring member-equipped adherend
20 wiring member
22, 122, 222, 322 sheet
322B raw sheet
23, 123 first layer (fusion layer)
24 second layer (long-fibered non-woven cloth layer)
24f fiber
25 press trace
26 wire-like transmission member
27 transmission wire body
28 covering layer
30 bonding part between sheet and wire-like transmission member (spot bonding part)
40 adherend
42 attached surface
50, 150, 250, 250A, 250B, 450, 550 bonding part between sheet and adherend
52, 152 lateral bonding part
53 overlapping bonding part
54 pressurized part
55 protruding part
60 non-bonding part
80 induction heating apparatus
82 press member
P1, P2 extension part

1. A wiring member-equipped adherend, comprising:
a wiring member including a sheet and a wire-like transmission member bonded to the sheet; and
an adherend provided in a position where the wiring member is disposed in a vehicle to be bonded to the sheet, wherein
a bonding part where the sheet and the adherend are bonded includes a lateral bonding part provided in a position deviated from the wire-like transmission member along a width direction of the sheet,
a plurality of spot bonding parts where the sheet and the wire-like transmission member are partially bonded along an extension direction of the wire-like transmission member are provided along the extension direction of the wire-like transmission member, and
the bonding part where the sheet and the adherend are fixed by a contact area fixation is provided between the plurality of spot bonding parts along the extension direction of the wire-like transmission member.

2. The wiring member-equipped adherend according to claim 1, wherein
a non-bonding part where the sheet and the adherend are not bonded is provided in a portion overlapped with the wire-like transmission member adjacent to the bonding part along the width direction of the sheet.

3. The wiring member-equipped adherend according to claim 2, wherein
a press trace is formed in a surface of the sheet in the lateral bonding part, and
a boundary between the bonding part and the non-bonding part is located closer to a side of the non-bonding part in relation to an edge of the press trace along the width direction of the sheet.

4. The wiring member-equipped adherend according to claim 2, wherein
the bonding part includes an overlapping bonding part provided adjacent to the lateral bonding part and partially overlapped with the wire-like transmission member.

5. (canceled)

6. The wiring member-equipped adherend according to claim 1, wherein
the bonding part includes a hot-melt adhesive agent intervening between the sheet and the adherend, and
a metal attached surface in the adherend has contact with the hot-melt adhesive agent.
